(19) United States
(12) Patent Application Publication
(10) Pub. No.: US 2009/0168443 A1
(43) Pub. Date: Jul. 2, 2009

(54) Reduced Glare Fog Lamp Assembly

(75) Inventor: Daniel T. Neubauer, Ann Arbor, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Erlanger, KY (US)

(21) Appl. No.: 11/965,115

(22) Filed: Dec. 27, 2007

(51) Int. Cl. B60Q 1/04

(52) U.S. Cl. 362/507

(57) ABSTRACT

A headlight is disposed along the front end of the vehicle for illuminating an area located forward of the front end of the vehicle. A fog lamp assembly is disposed along the front end of the vehicle and below the headlight. The fog lamp assembly includes a housing; a front lens; a support wall; and a bulb having a base adapted to be removably connected to the support wall. The bulb has a light-emitting filament encased in a shell that extends from the base. The shell is substantially translucent to allow light from the filament to pass therethrough. The shell has a distal end spaced apart from the base. The bulb is angled outwardly toward a side of the vehicle at a predetermined angle relative to a longitudinal axis of the vehicle so that light from the filament illuminates an area both forward and to the side of the vehicle and so that some of the light from the filament is blocked by a nontranslucent portion of the distal end to prevent glare light from the front lens.

### FIELD OF THE INVENTION

The invention relates to a fog lamp assembly for a motor vehicle for illuminating an outside area adjacent to the vehicle and providing reduced glare light.

### BACKGROUND OF THE INVENTION

Motor vehicles typically include headlights for illuminating an area in front of the vehicle while driving at night or in low-light condition. Some vehicles also include fog lamps for illuminating an area immediately in front of the vehicle to improve visibility while driving in foggy or rainy conditions. It remains desirable to provide a fog lamp arrangement that illuminates an area immediately in front of the vehicle and also to the side of the vehicle to widen the illuminated field of view, while minimizing or eliminating glare light.

### SUMMARY OF THE INVENTION

According to one embodiment of the invention, a motor vehicle includes a front end extending transversely between opposite sides of the vehicle. A headlight is disposed along the front end of the vehicle for illuminating an area located forward of the front end of the vehicle. A fog lamp assembly is disposed along the front end of the vehicle and below the headlight. The fog lamp assembly includes a housing; a front lens; a support wall; and a bulb having a base adapted to be removably connected to the support wall. The bulb has a light-emitting filament encased in a shell that extends from the base. The shell is substantially translucent to allow light from the filament to pass therethrough. The shell has a distal end spaced apart from the base. The bulb is angled outwardly toward a side of the vehicle at a predetermined angle relative to a longitudinal axis of the vehicle so that light from the filament illuminates an area both forward and to the side of the vehicle and so that some of the light from the filament is blocked by a nontranslucent portion of the distal end to prevent glare light from the front lens.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is a front perspective view of a motor vehicle according to one embodiment of the invention; and

FIG. 2 is a cross sectional view of the motor vehicle in FIG. 1 showing a lamp assembly for illuminating an area both forward and to the side of the vehicle.

### DETAILED DESCRIPTION OF THE INVENTION

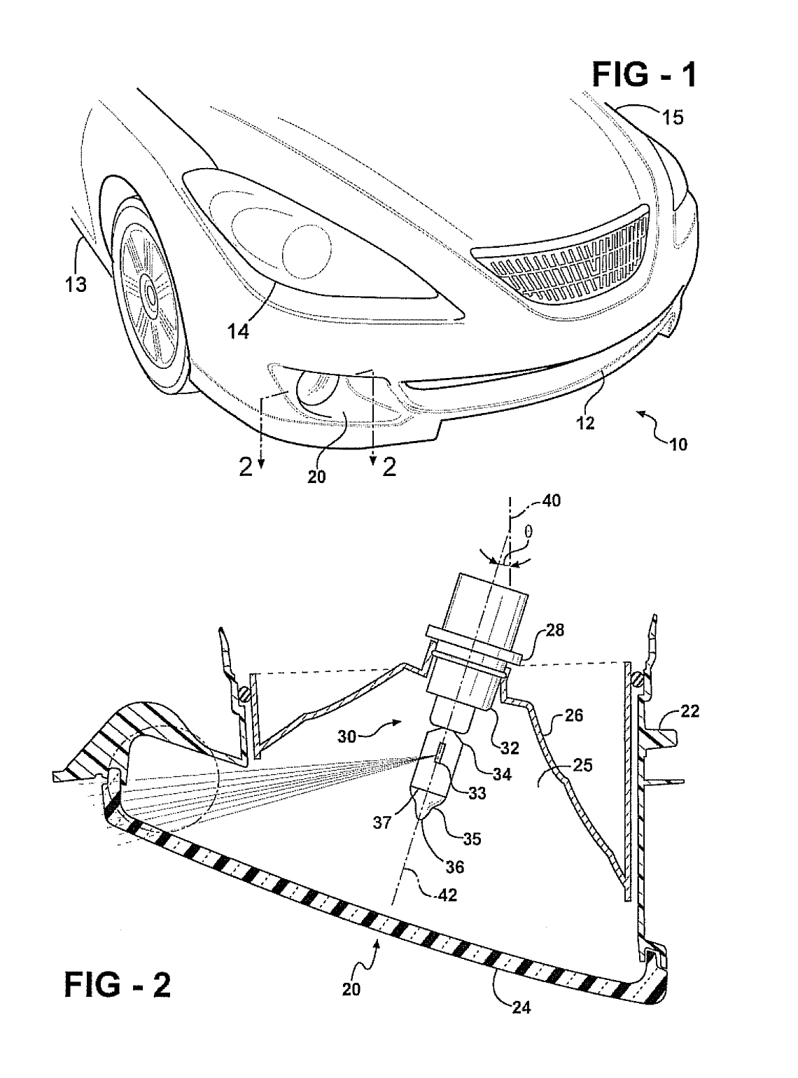

Referring to FIG. 1, a motor vehicle according to one embodiment of the invention is generally indicated at 10. The motor vehicle 10 includes a front end 12 extending transversely between opposite sides 13, 15 of the vehicle 10. A headlight 14 is disposed along the front end 12 of the vehicle 10 for illuminating an area located forward of the front end of the vehicle. A fog lamp assembly 20 is disposed along the front end 12 of the vehicle 10 and below the headlight 14. Described in detail below, the fog lamp assembly 20 illuminates an area both forward and to one side of the vehicle 10.

The fog lamp assembly 20 includes a housing 22 having a generally translucent front lens 24 and a support wall 26. The front lens 24 and support wall 26 are spaced apart to define a generally enclosed space 25. A bulb 30 is disposed in the space 25. More specifically, the bulb includes a base 32 adapted to be removably connected to the support wall 26. The bulb 30 has a light-emitting filament 33 encased in a shell 34 that extend 36s from the base 32. The shell 34 is substantially translucent to allow light from the filament 33 to pass therethrough. The shell 34 has a distal end 36 spaced apart from the base 32. At least a portion of the distal end 36 of the shell 34 is nontranslucent. The bulb 30 extends along a longitudinal axis 42 is offset or angled outwardly toward a side of the vehicle 10, indicated at angle θ in FIG. 2, relative to a for and aft extending axis 40 of the vehicle 10. The front lens 24 is spaced apart from the distal end 36 of the bulb 30. In one embodiment, the angle θ is approximately 24 degrees and/or the distance between the front lens 24 and the distal end 36 of the bulb 30 is approximately 35 mm. The front lens 24 is generally orthogonal to the longitudinal axis 42 of the bulb 30.

In one embodiment, the nontranslucent portion 35 of the distal end 36 of the bulb 30 is generally conical shaped and has a base 37 with a diameter of approximately 12 mm. The base 37 of the nontranslucent portion 35 is spaced apart from the filament 33 by a distance of approximately 4 mm. In this embodiment, the shell is generally cylindrical and has a diameter corresponding with the base 37.

By the fog lamp arrangement described, light from the filament 33, both direct and reflected, illuminates an area both forward and to the side of the vehicle 10 and, at the same time, a portion of the light from the filament 33 is blocked by the nontranslucent portion 35 of the distal end 36 to prevent glare light.

The invention has been described in an illustrative manner. It is, therefore, to be understood that the terminology used is intended to be in the nature of words of description rather than of limitation. Many modifications and variations of the invention are possible in light of the above teachings. Thus, within the scope of the appended claims, the invention may be practiced other than as specifically described.

I claim:

1. A motor vehicle comprising:
a front end extending transversely between opposite sides of the vehicle;
a headlight disposed along the front end of the vehicle for illuminating an area located forward of the front end of the vehicle; and
a fog lamp assembly disposed along the front end of the vehicle and below the headlight, the fog lamp assembly comprising:
a housing;
a front lens;
a support wall; and
a bulb having a base adapted to be removably connected to the support wall, the bulb having a light-emitting filament encased in a shell that extends from the base, the shell of the bulb being substantially translucent to allow light from the filament to pass therethrough, the shell of the bulb having a distal end spaced apart from the base, the bulb extending along a longitudinal axis that is angled outwardly toward a side of the vehicle at a predetermined angle relative to a fore and aft axis of the vehicle so that light from the filament illuminates an area both forward and to the side of the vehicle and so that some of the light from the filament is blocked by a nontranslucent portion of the distal end to prevent glare light from the front lens.

2. A motor vehicle as set forth in claim 1, wherein the nontranslucent portion is generally conical shaped.

3. A motor vehicle as set forth in claim 2, wherein the nontranslucent portion has a base with a diameter of approximately 12 mm.

4. A motor vehicle as set forth in claim 3, wherein the base of the nontranslucent portion is spaced apart from the filament by a distance of approximately 4 mm.

5. A motor vehicle as set forth in claim 4, wherein the predetermined angle is approximately twenty four degrees.

6. A motor vehicle as set forth in claim 5, wherein the shell is generally cylindrical and has a diameter corresponding with the base of the nontranslucent portion.

7. A motor vehicle as set forth in claim 5, wherein the front lens is generally orthogonal to the longitudinal axis of the bulb.

8. A motor vehicle as set forth in claim 7, wherein the front lens is spaced apart from the distal end of the bulb by a distance of approximately 35 mm.
